(19) United States
(12) Patent Application Publication
(10) Pub. No.: US 2020/0143250 A1
(43) Pub. Date: May 7, 2020

(54) METHOD AND APPARATUS FOR COMPRESSING/DECOMPRESSING DEEP LEARNING MODEL

(71) Applicant: ELECTRONICS AND TELECOMMUNICATIONS RESEARCH INSTITUTE, Daejeon (KR)

(72) Inventor: Yong-Ju LEE, Daejeon (KR)

(21) Appl. No.: 16/674,484

(22) Filed: Nov. 5, 2019

(30) Foreign Application Priority Data
Nov. 6, 2018 (KR) 10-2018-0135468

(51) Int. Cl. G06N 3/08; G06N 3/04

(52) U.S. Cl. CPC G06N 3/082; G06N 3/04

(57) ABSTRACT

Method and apparatus for compressing and decompressing a deep learning model. The apparatus for compressing extracts a threshold from a weight matrix for each layer of a pre-trained deep learning model, generate a binary mask for the weight matrix based on the threshold for each layer, apply the binary mask to the weight matrix for each layer of the pre-trained deep learning model, and perform a matrix sparsity process to generate a compression model.

### CROSS-REFERENCE TO RELATED APPLICATION

This application claims priority to and the benefit of Korean Patent Application No. 10-2018-0135468, filed in the Korean Intellectual Property Office on Nov. 6, 2018, the entire content of which is incorporated herein by reference.

### BACKGROUND OF THE INVENTION

### 1. Field of the Invention

The present invention relates to deep learning, and more particularly, to a method and apparatus for compressing and decompressing a deep learning model.

### 2. Description of Related Art

There is a growing interest in artificial intelligence (AI). Artificial intelligence involves machine learning in which it is allowed for a machine to read a large amount of learning data and create rules for inference, such as classification and judgment. The machine learning process includes a learning process of making an inference model that is a model for performing inference by extracting features from a large amount of learning data, and an inference process of applying given data to the inference model to derive inference results.

Recently, research on human brain activity has progressed, and deep learning, a method of applying machine learning, has emerged. In machine learning before deep learning, humans had to determine and set feature quantities, but in deep learning, machines interpret data to automatically find optimal feature quantities. As a result, as the amount of data to be interpreted increases, the performance can be further improved without depending on human experience or misunderstanding.

Such machine learning/deep learning is widely used in various applications such as visual recognition, natural language understanding, autonomous driving, and future prediction of the overall industry. Traditional machine learning/deep learning is a form of sufficiently training a model on a server (or cloud) through a high speed computing device and providing an application to users. Nowadays, the deep learning model light weight technology for efficiently performing deep learning in small devices such as smart phones is attracting attention.

In the future, machine learning/deep learning is expected to be applied to home appliances, autonomous vehicles, robots, the Internet of Things (IoT) devices, and the like. However, in order to use a trained model, there is a model file that stores the weights of the model, and these models vary in size from several megabytes to several hundred megabytes. Therefore, it is not suitable to apply existing models efficiently in small devices. In particular, in the case of On-device AI, where a trained model file is moved to a small device and deep learning inference is performed without the help of a server (or cloud), continuous model updating (or transmission) is performed. This requires a reduction (or compression) of the deep learning model.

A related prior art document is an iterative deep learning quantization algorithm and method for weighted bit reduction described in Korean Patent Application Publication No. 10-2018-0082344.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus that can effectively compress and decompress a deep learning model.

An exemplary embodiment of the present invention provides a method of compressing a deep learning model. The method includes: extracting, by a compression device, a threshold from a weight matrix for each layer of a pre-trained deep learning model; generating, by the compression device, a binary mask for the weight matrix based on the threshold for each layer; and applying, by the compression device, the binary mask to the weight matrix for each layer of the pre-trained deep learning model and performing a matrix sparsity process to generate a compression model.

The generating a binary mask may include: comparing a weight value of the weight matrix with the threshold; and generating the binary mask by assigning a value of 0 when the weight value is less than the threshold and by assigning a value of 1 when the weight value is greater than the threshold.

The applying the binary mask may include multiplying the binary mask by the weight matrix of each layer of the pre-trained deep learning model to obtain a new weight matrix to which the binary mask is applied.

The applying the binary mask may include performing a matrix sparsity process on the weight matrix to which the binary mask is applied for each layer of the pre-trained deep learning model to obtain a sparse matrix including shape information of the weight matrix, index information representing a position of a weight value, and value information representing an actual value of a weight value corresponding to the position.

The method may further include, before the extracting a threshold, receiving an expectation ratio of compression, wherein the threshold is changed according to the expectation ratio of compression.

The method may further include, after the applying the binary mask: comparing accuracy of the compression model with accuracy of the pre-trained deep learning model; changing the expectation ratio of compression when it is determined that the comparison result is within a setting range and the accuracy of the compression model is maintained at the setting level; and ending a compression process and outputting the compressed model when it is determined that the comparison result is out of the setting range and the accuracy of the compression model is not maintained at the setting level.

The extracting a threshold, the generating a binary mask, and the applying the binary mask based on expectation ratio of compression being changed may be repeatedly performed while it is determined that the comparison result is within the setting range.

The method may further include transmitting the compression model to a terminal device via a network, wherein the compression model may have a size that is less than a size of the pre-trained deep learning model.

Another embodiment of the present invention provides a method for decompressing a compressed deep learning model. The method includes: obtaining, by a decompression device, information of a sparse matrix from the compressed deep learning model, wherein the compressed deep learning model includes a sparse matrix for each layer compressed by a binary mask and a matrix sparsity process; generating, by the decompression device, a matrix having values of 0 in a form of one dimension for each layer of the compressed deep learning model; substituting, by the decompression device, a value into the generated matrix based on the obtained information of the sparse matrix; and obtaining, by the decompression device, a decompressed model by converting the matrix substituted with the value into an N-dimensional matrix.

The information of the sparse matrix may include shape information of a weight matrix, index information representing a position of a weight value, and value information representing an actual value of a weight value corresponding to the position.

The generating a matrix may include generating a one-dimensional matrix having values of 0 based on the shape information, and the substituting a value may include substituting an actual value of the value information corresponding to a position of the index information into a position of the one-dimensional matrix corresponding to the position of the index information.

The obtaining a decompressed model may include converting the matrix substituted with the value into an N-dimensional matrix based on the shape information.

The method may further include, before the obtaining information of a sparse matrix, receiving, by the decompression device, the compressed deep learning model via a network.

Yet another embodiment of the present invention provides an apparatus for compressing. The apparatus includes: an interface configured to receive a pre-trained model; and a processor configured to compress the pre-trained model, wherein the processor is configured to extract a threshold from a weight matrix for each layer of the pre-trained deep learning model, generate a binary mask for the weight matrix based on the threshold for each layer, apply the binary mask to the weight matrix for each layer of the pre-trained deep learning model, and perform a matrix sparsity process to generate a compression model.

The processor may be specifically configured to generate the binary mask by comparing a weight value of the weight matrix with the threshold, multiply the binary mask by the weight matrix of each layer of the pre-trained deep learning model to obtain a new weight matrix to which the binary mask is applied, and perform a matrix sparsity process on the new weight matrix.

The processor may be specifically configured to perform a matrix sparsity process on the weight matrix to which the binary mask is applied for each layer of the pre-trained deep learning model to obtain a sparse matrix including shape information of the weight matrix, index information representing a position of a weight value, and value information representing an actual value of a weight value corresponding to the position.

The threshold may be changed according to the expectation ratio of compression received by the interface.

Yet another embodiment of the present invention provides an apparatus for decompressing. The apparatus includes: a network interface configured to receive a compressed deep learning model over a network; and a processor configured to decompress the compressed deep learning model, wherein the processor is configured to obtain information of a sparse matrix from the compressed deep learning model, wherein the compressed deep learning model includes a sparse matrix for each layer compressed by a binary mask and a matrix sparsity process, generate a matrix having values of 0 in a form of one dimension for each layer of the compressed deep learning model, substitute a value into the generated matrix based on the obtained information of the sparse matrix, and obtain a decompressed model by converting the matrix substituted with the value into an N-dimensional matrix.

The information of the sparse matrix may include shape information of a weight matrix, index information representing a position of a weight value, and value information representing an actual value of a weight value corresponding to the position.

The processor may be specifically configured to generate a one-dimensional matrix having values of 0 based on the shape information, substitute an actual value of the value information corresponding to a position of the index information into a position of the one-dimensional matrix corresponding to the position of the index information, and convert the matrix substituted with the value into an N-dimensional matrix based on the shape information.

### BRIEF DESCRIPTION OF THE DRAWINGS

FIG. 1 is an exemplary diagram illustrating a deep learning process for performing pre-training and determination in a server and transmitting the result to a mobile device.

FIG. 2 is an exemplary diagram illustrating a prediction process in classifying images.

FIG. 3 is an exemplary diagram illustrating weights using various layers of a general deep learning model.

FIG. 4 is a diagram illustrating a process for compressing a deep learning model according to an embodiment of the present invention.

FIG. 5 is a flowchart illustrating a method for compressing a deep learning model according to an embodiment of the present invention.

FIG. 6A and FIG. 6B are diagrams illustrating a process of extracting a threshold in a method for compressing according to an embodiment of the present invention.

FIG. 7A and FIG. 7B are diagrams illustrating a process of generating a binary mask in a method for compressing according to an exemplary embodiment of the present invention.

FIG. 8A and FIG. 8B are diagrams illustrating a process of applying a binary mask to a model in a method for compressing according to an exemplary embodiment of the present invention.

FIG. 9A and FIG. 9B are diagrams illustrating a matrix sparsity process in a method for compressing according to an exemplary embodiment of the present invention.

FIG. 10 is a flowchart illustrating a method for decompressing a deep learning model according to an embodiment of the present invention.

FIG. 11 is an exemplary diagram illustrating a process for decompressing a compressed model according to an embodiment of the present invention.

FIG. 12A and FIG. 12B are exemplary diagrams illustrating a detailed layer configuration of a neural network (MobileNet) used in an embodiment of the present invention.

FIG. 13 illustrates exemplary compression ratios of layers of a neural network based on a method for compressing a model according to an exemplary embodiment of the present invention.

FIG. 14 is an exemplary diagram comparing a size of an existing model with a size of a compression model to which an expectation ratio of compression is applied in a method for compressing a model according to an embodiment of the present invention.

FIG. 15 is an exemplary diagram comparing the accuracy of an existing model and the accuracy of a compressed model according to a method for compressing a model according to an embodiment of the present invention.

FIG. 16 is a graph illustrating model size and accuracy according to an expectation ratio of compression of a model compressed in accordance with a method according to an exemplary embodiment of the present invention.

FIG. 17 is a structural diagram of an apparatus for compressing a model according to an embodiment of the present invention.

FIG. 18 is a structural diagram of an apparatus for decompressing a model according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

The expressions described in the singular may be interpreted as singular or plural unless an explicit expression such as “one”, “single”, and the like is used.

Hereinafter, a method and apparatus for compressing and decompressing a deep learning model according to an embodiment of the present invention will be described.

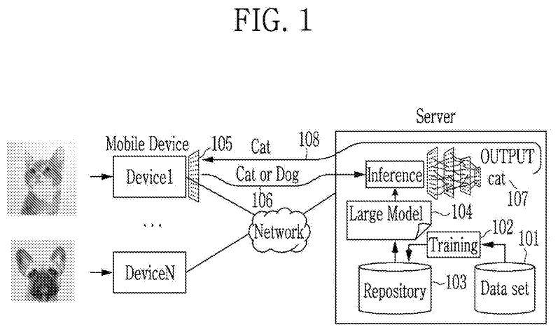

FIG. 1 is an exemplary diagram illustrating a deep learning process for performing pre-training and determination in a server and transmitting the result to a mobile device.

In general, for deep learning, the deep learning system (or server) prepares a data set 101 for training and performs training 102 for applying various deep learning algorithms, that is, a deep learning model to the data set 101, as shown in FIG. 1. The trained deep learning model is stored in a repository 103. This pre-trained model is loaded into a memory, and prediction 107 is performed to obtain inference results.

In a device (device 1 to device N) such as a mobile device, as shown in FIG. 1, when determining a picture of a dog and a cat, a photo image is extracted by the mobile device, and the extracted image 105 is transmitted to the server in order to request the server to determine whether an object of the extracted image is a dog or a cat (106). The data transmitted in the requesting is a photo image. The server determines whether the object of the requested data is a dog or a cat through the deep learning model, and transmits the determination result to a mobile device (108). In other words, the server loads the pre-trained model into a memory and performs prediction 107 on the requested photographic image using the pre-trained model to determine whether the object of the photographic image is a dog or a cat, and transmits the determination result to the mobile device.

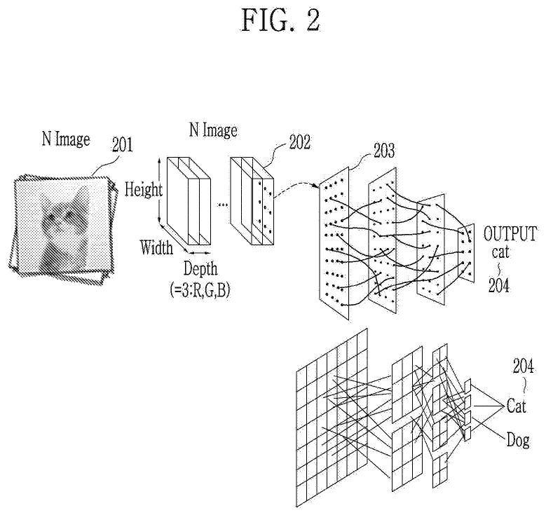

FIG. 2 is an exemplary diagram illustrating a prediction process in classifying images.

Prediction processing performed at the server may be performed as follows. In the case of image classification, prediction must be performed each time for each of various images (N images) 201. When one image 202 is a color image, it includes three images of a red image, a green image, and a blue image, which may be collectively referred to as an RGB image. Each of the RGB images includes as many image points as the number corresponding to the value of width (W)×height (H). These image points can be represented by an image matrix, which, through image inference 203 and 204, predicts a particular label. In this process, the image matrix is represented by the values of the weight, which is called the weight matrix.

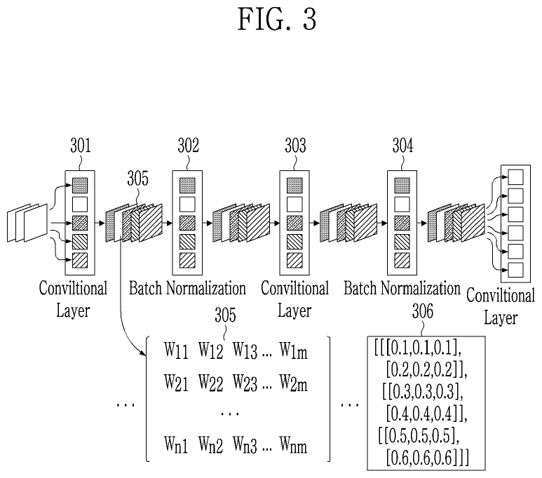

FIG. 3 is an exemplary diagram illustrating weights using various layers of a general deep learning model.

As shown in FIG. 3, for image inference, features of the original data are extracted through various layers 301 to 304 of the deep learning model. In this case, the extracted features, that is, the information of the various layers, is in the same form as a weight matrix 305. As in one example 306 of the weight matrix, each point in the matrix has one value.

In deep learning processing as described above, a trained model is very large, ranging in size from several megabytes to hundreds of megabytes. This large model is not suitable for application in small devices such as mobile devices. Therefore, when deep learning inference is performed without the help of a server (or cloud), the mobile device performs update (or transmission) of a stored model. However, the file size of the stored model file is so large that the update process is not easy.

In an embodiment of the present invention, the pre-trained model is compressed and the compressed model is transmitted.

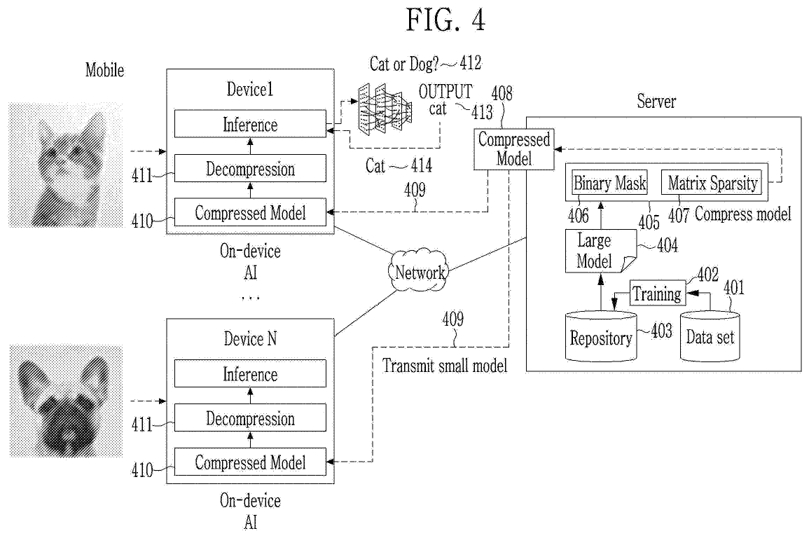

FIG. 4 is a diagram illustrating a process for compressing a deep learning model according to an embodiment of the present invention.

In an embodiment of the present invention, the server compresses and transmits a model in which pre-training is completed and then enables terminal-based determination.

Specifically, as shown in FIG. 4, the server prepares a data set 401 for training, applies various deep learning algorithms (a deep learning model) to the data set for training 402, and stores the trained model in a repository (403).

Unlike loading a previously trained model into a memory to perform prediction, in an embodiment of the present invention, compression 405 on the trained model 404 is performed. In an embodiment of the present invention, a binary mask technique 406 and a matrix sparsity process 407 are performed to compress the trained model. This will be described in more detail later. The compressed model is significantly reduced in size compared to the existing model 404. The server transmits the compressed model 408 to the mobile device (or a terminal), and the mobile device directly performs prediction (for example, on-device artificial intelligence (AI)). The mobile device receives the compressed model over the network 409 and performs decompression 411 on the received compressed model 410. The mobile device then loads the decompressed model into the memory of the mobile device to perform prediction.

In an embodiment of the present invention, the mobile device directly performs prediction on the photo image by using the decompressed model to obtain the result of the inference, instead of performing a request for determining whether the object of the photo image is a dog or a cat while transmitting the photo image to the server. In prediction by the mobile device, specifically, the mobile device extracts the photo image and performs inference 412 using the decompressed model loaded into a memory to determine whether the object of the photo image is a dog or a cat (413, 414).

In this embodiment of the present invention, the model compression process does not go through a network transmission step in the future, and has a performance advantage even in a network disconnection or a frequent prediction process.

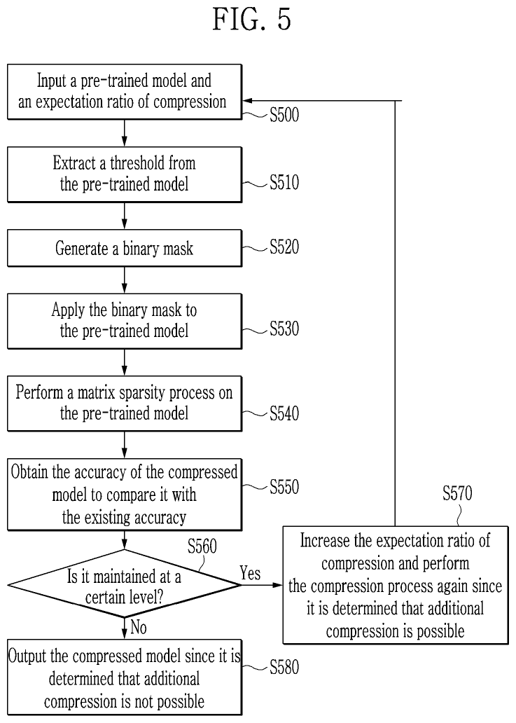

FIG. 5 is a flowchart illustrating a method for compressing a deep learning model according to an embodiment of the present invention.

As shown in FIG. 5, first, a pre-trained model and an expectation ratio of compression are input (S500). Here, the pre-trained model is a sufficiently trained model through a training data set, and has a certain value of accuracy through a test data set.

Next, a threshold is extracted from the pre-trained model (S510). For each layer constituting the pre-trained model, the threshold is extracted from a weight matrix having a weight value corresponding to a feature of the original data of each layer. After spreading the entire weight matrix in a one-dimensional array, the value of the actual weight for reaching the expectation ratio of compression is extracted as the threshold.

Thereafter, a binary mask is generated for each matrix (S520). The binary mask may be one of a binary mask having 1 for maintaining the existing weight for each weight matrix and a binary mask having 0 for erasing the value of the weight matrix. For example, a weight value corresponding to each point of the weight matrix and a threshold is compared, and a binary mask having a value of 0 is generated when the weight value is less than the threshold and a binary mask having a value of 1 is generated when the weight value is greater than the threshold.

Next, the generated binary mask is applied to the pre-trained model to perform a matrix sparsity process on the pre-trained model (S530 to S540). This process produces a new model, that is, a compressed model, which is processed with a binary masked and then made sparse.

The test data set is applied to the compressed model to measure the accuracy again, and the accuracy of the existing training model is compared with the accuracy of the compressed model (S550).

When comparing the accuracy of the existing training model with the accuracy of the compressed model, if the accuracy of the compressed model is maintained at a certain level (S560), for example, if the accuracy of the compressed model is lower than that of the existing training model, but the difference between the accuracy of the existing training model and the accuracy of the compressed model is smaller than a set value, it is determined that additional compression is possible, thereby increasing the expectation ratio of compression and performing the compression process again (S570). Accordingly, the above-described steps S500 to S560 are repeatedly performed based on the new expectation ratio of compression and the compressed model.

On the other hand, in step S560, when the accuracy of the existing training model and the accuracy of the compressed model are compared, if the accuracy of the compressed model is not maintained at a certain level, for example, if the accuracy of the compressed model is lower than the accuracy of the existing training model and the difference is greater than the set value, it is determined that additional compression is not possible and the compression is terminated, and the compressed model is output (S580).

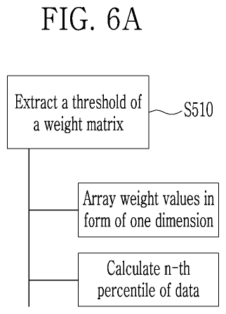

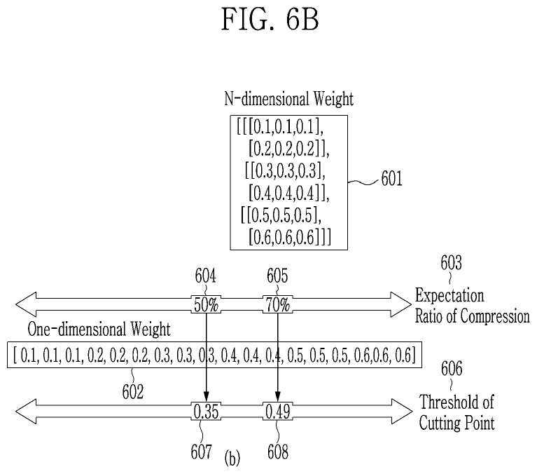

FIG. 6A and FIG. 6B are diagrams illustrating a process of extracting a threshold in a method for compressing according to an embodiment of the present invention.

For an embodiment of the present invention, a process of extracting a threshold from a pre-trained model (S510 of FIG. 5) will be described in more detail as follows. As shown in FIG. 6A, the pre-trained model is converted into an array having a weight value in one dimension. Specifically, as shown in FIG. 6B, for each layer constituting the pre-trained model, an N-dimensional weight matrix 601 having weight values corresponding to features of the original data of each layer is converted into an array 602 having weight values in a form of one dimension.

Using the array 602, threshold extraction is performed starting with an arbitrary value (hereinafter referred to as a starting expectation ratio of compression) that is less than the expectation ratio of compression (604). In FIG. 6B, the case where the expectation ratio of compression is 70% and the starting expectation ratio of compression is 50% is presented as an example. The truncation value 607 (which may also be referred to as a threshold of cutting point 606 and is a percentile) of the actual weight matrix when the compression expectancy ratio 603 is 50% (604) is 0.35, and a truncation value 608 of the actual weight matrix when the compression expectation 603 is 70% (605) is 0.49. The truncation value of the actual weight matrix is used as the threshold.

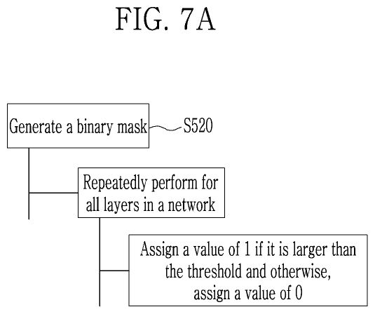

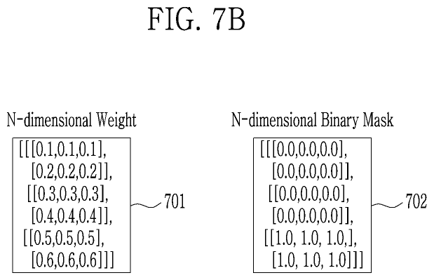

FIG. 7A and FIG. 7B are diagrams illustrating a process of generating a binary mask (S520 of FIG. 5) in a method for compressing according to an exemplary embodiment of the present invention.

In FIG. 7A and FIG. 7B, a process of generating an N-dimensional binary mask by using the truncation value 0.49 of the actual weight matrix extracted in the example of FIG. 6 as a threshold is exemplarily illustrated.

As shown in FIGS. 7A and 7B, a binary mask (N-dimensional binary mask) 702 having the same shape as the original N-dimensional weight matrix 701 is generated. Specifically, the process of comparing the weight value of the weight matrix and the threshold is repeatedly performed for all layers in the neural network. The binary mask 702 is generated by assigning a value of 0 if the weight value of the weight matrix is smaller than the threshold, and assigning a value of 1 if the weight value of the weight matrix is larger than the threshold.

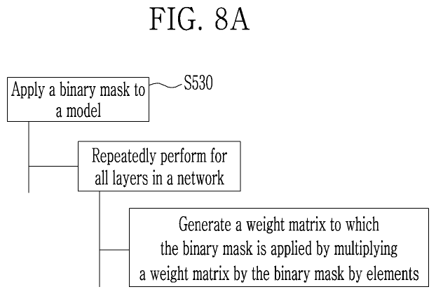

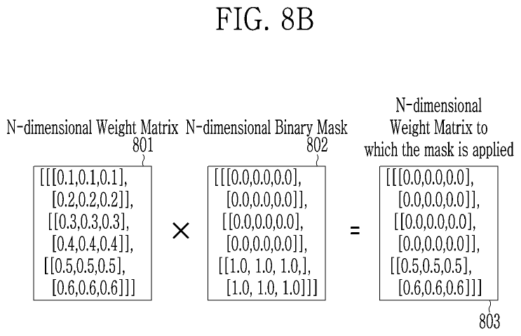

FIG. 8A and FIG. 8B are diagrams illustrating a process of applying a binary mask to a model in a method for compressing according to an exemplary embodiment of the present invention.

In FIG. 8A and FIG. 8B, the N-dimensional binary mask is applied to the N-dimensional weight matrix. Specifically, as shown in FIG. 8A, a process of applying a binary mask (S530 of FIG. 5) is repeatedly performed for all layers in the neural network. Specifically, as shown in FIG. 8B, the binary mask 802 generated in FIGS. 7A and 7B and the N-dimensional weight matrix 801 are multiplied to obtain the new N-dimensional weight matrix 803 to which the binary mask is applied. This process is performed layer by layer. Here, the N-dimensional weight matrix 801 and the binary mask 802 (that is, the N-dimensional binary mask) are multiplied by elements to obtain a new N-dimensional weight matrix, that is, the new N-dimensional weight matrix 803.

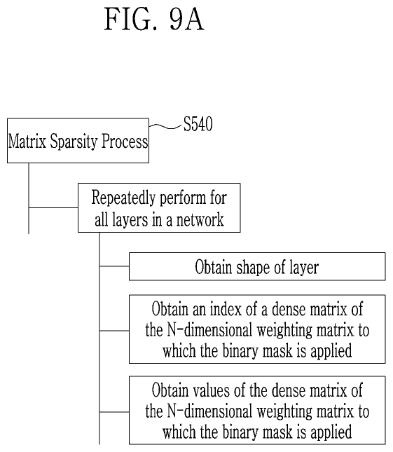

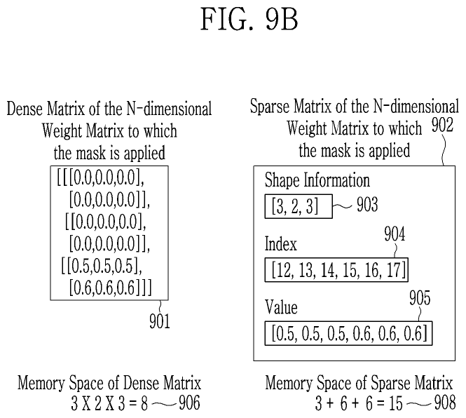

FIG. 9A and FIG. 9B are diagrams illustrating a matrix sparsity process in a method for compressing according to an exemplary embodiment of the present invention. In FIG. 9A and FIG. 9B, an application for sparse matrix storage is exemplarily shown, and a data structure for actually storing weight matrixs to which all binary masks of a neural network are applied is illustrated.

Specifically, as shown in FIG. 9A, a matrix sparsity process (S540 of FIG. 5) is repeatedly performed on all layers in the neural network. For each layer, a shape of a layer is obtained, and an index of a dense matrix of the weighting matrix to which the binary mask is applied is obtained. Then, actual values of the dense matrix of the weight matrix to which the binary mask is applied are obtained.

Through this sparse matrixing process, as shown in FIG. 9B, the N-dimensional weight matrix 901 to which the binary mask is applied may be represented by shape information 903 indicating the shape of the weight matrix, index information 904 indicating positions of weights in the weight matrix, and value information 905 indicating the actual values of the weights. For example, the N-dimensional weight matrix 901 to which the binary mask is applied is a matrix composed of all 18 values, while the sparse matrix 902 of the N-dimensional weight matrix 901 to which the binary mask is applied is composed of all 15 values. Specifically, the sparse matrix 902 is represented with three values representing the shape information 903, six values representing the index information 904 indicating positions of weights, and six values representing the value information 905 indicating actual values corresponding to the positions of the index information. Here, the memory space 906 of the dense matrix and the memory space 908 of the sparse matrix are as shown in FIG. 9B.

Thus, a binary mask is applied to the weight matrix of the existing model, and then the matrix sparsity process is performed on the weight matrix to which the binary mask is applied so that a sparse matrix consisting of the shape information, the index information indicating weight's positions, and the value information indicating actual values of the weights (also referred to as a model's value) is obtained. A sparse matrix for each of all layers in the neural network is obtained and a compression model including the sparse matrixes for the layers is finally obtained.

On the other hand, the method for compressing according to an embodiment of the present invention can be performed as described above, and the server compresses the model according to the above method and then transmits it to the mobile device. The mobile device receives the compressed model and decompresses the received compressed model. In other words, the model decompression process is performed directly by the mobile device.

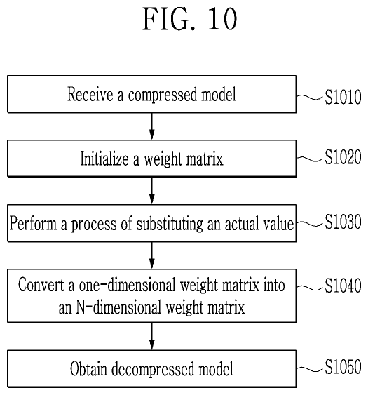

FIG. 10 is a flowchart illustrating a method for decompressing a deep learning model according to an embodiment of the present invention.

As shown in FIG. 10, a compressed model is received from a server through a network (S1010).

The mobile device loads the received compressed model into a memory, and initializes a weight matrix constituting the model. First, the mobile device initializes the weight matrix (one-dimensional (ID) weight matrix) by filling it with zeros (S1020). That is, an initialized matrix having values of 0 in a form of one dimension is generated based on the shape information obtained from the sparse matrix of the received compressed model, and here, the sparse matrix is a sparse matrix of the N-dimensional weight matrix to which the binary mask is applied, that is, a sparse matrix to which the binary mask is applied.

Subsequently, a process which obtains the index information and the value information stored in the compressed model and substitutes actual values corresponding to the value information for values of 0 at positions corresponding to the index information in the initialized matrix is performed (S1030).

Next, the model in which the actual value is substituted is converted into the same shape as the existing model (S1040). That is, the one-dimensional weight matrix in which the actual value is substituted is converted into the N-dimensional weight matrix. After performing all of these processes, a model having the same shape as that of the existing model, that is, the decompressed model, is obtained (S1050).

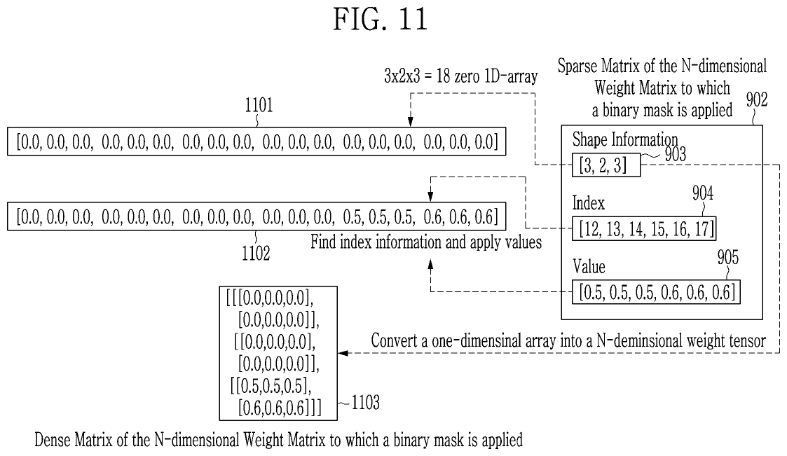

FIG. 11 is an exemplary diagram illustrating a process for decompressing a compressed model according to an embodiment of the present invention.

It is possible to recover the original N-dimensional weight matrix from the information of the sparse matrix to which the binary mask is applied.

As shown in FIG. 9B above, the sparse matrix to which the binary mask is applied according to an embodiment of the present invention is obtained, and the sparse matrix 902 includes shape information 903, index information 904, and value information 905 indicating actual values.

Based on this, as shown in FIG. 11, first, a matrix 1101 having values of 0 in one dimension is generated based on the shape information 903. If the shape information 903 is [3, 2, 3], a one-dimensional matrix with 18 zeros through 3×2×3=18 is generated. Here, the 18 zeros are represented in a form of 0.0, respectively based on [2] the shape information of [3, 2, 3].

Next, the actual value is substituted into the one-dimensional matrix 1101 having values of zero based on the index information 904 indicating the position and the value information 905 indicating the actual value. That is, the updated matrix 1102 is obtained by substituting actual values of the value information 905 at positions corresponding to the index information 904 in the one-dimensional matrix 1101 having values of zero. For example, an actual value “0.5” of the value information 905 corresponding to “12” of the index information 904 is substituted for “0.0” at the 12th position of the one-dimensional matrix 1101 according to “12” of the index information 904. Through this by using the index information 904 and the value information 905, an updated matrix 1102 is obtained. Finally, the updated matrix 1102 is transformed into an N-dimensional form based on the shape information 903 to restore the original N-dimensional weight matrix 1103 to before being compressed.

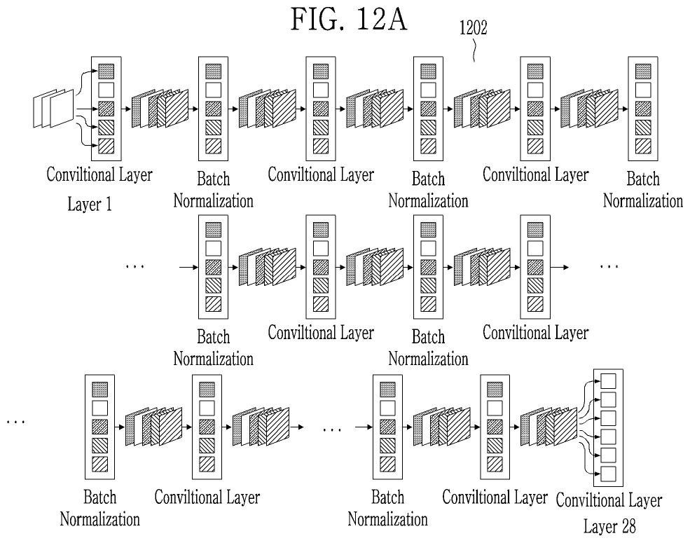

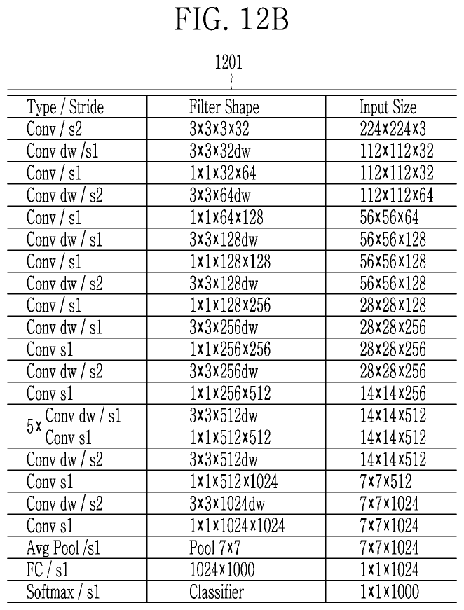

FIGS. 12A and 12B are exemplary diagrams showing a detailed layer configuration of a neural network (MobileNet) used in an embodiment of the present invention.

The neural network (MobileNet) illustrated in FIGS. 12A and 12B is a network structure made for a mobile and embedded system proposed by Google. The structure of the neural network according to the embodiment of the present invention is not limited to a specific structure, and the method according to the embodiment of the present invention is applicable to various neural networks. The neural network structure 1202 illustrated in FIG. 12A is a neural network structure formed by stacking a total of 28 layers, and corresponds to a structure in a form of a table 1201 illustrated in FIG. 12B.

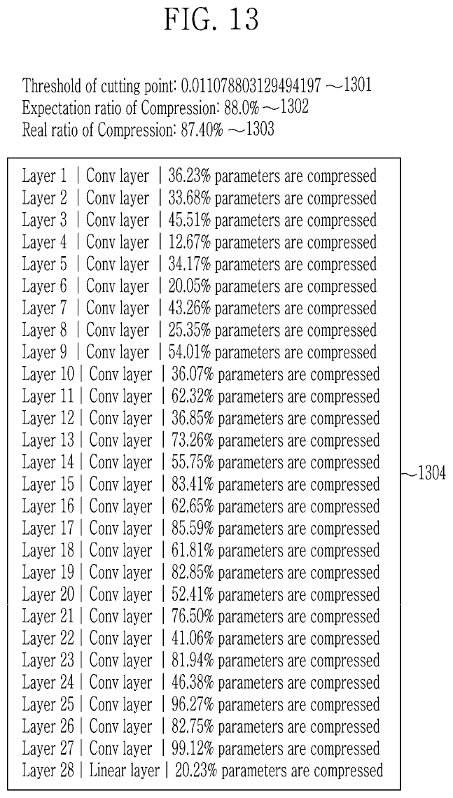

FIG. 13 illustrates exemplary compression ratios of layers of a neural network based on a method for compressing a model according to an exemplary embodiment of the present invention. In FIG. 13, a model compressed through model compression in an existing neural network (MobileNet) (see FIG. 12B) is exemplary used.

In FIG. 13, an example in which the truncation value 1301 of the weight matrix is about 0.01107 and the expectation ratio of compression 1302 is about 88.0% is presented. The real ratio of compression 1303 performed through the expectation ratio of compression is 87.40%. The real ratio of compression 1304 of the weights compressed for each layer of the existing neural network (MobileNet) can be seen.

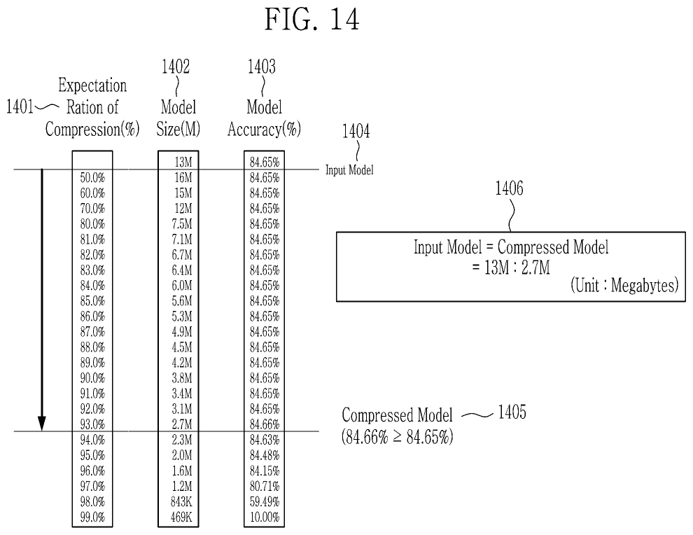

FIG. 14 is an exemplary diagram comparing a size of an existing model with a size of a compression model to which an expectation ratio of compression is applied in a method for compressing a model according to an embodiment of the present invention.

In the case where the expectation ratio of compression 1401 has no loss of accuracy from 50% to 93.0%, it is assumed that the expectation ratio of compression continues to increase and the final expectation ratio of compression reaches 93.0%. For model accuracy 1403, the accuracy 1404 of the original model (e.g., an input model) is 84.65% and the accuracy 1405 of the newly generated compressed model is 84.65%. While the accuracy of the compressed model maintains the accuracy of the original model, the size of the actual model 1402 is significantly reduced from 13 MB of the original model to 2.7 MB of the compressed model (1406). This is about 20% of the size of the model of the existing neural network (MobileNet). In addition, when the accuracy of the existing model is reduced by about 4%, compression is possible from the size of 13 MB of the existing model to 1.2 MB based on the accuracy of 80.71% of the compression model. This is about 10% of the size of the existing model.

Therefore, it can be seen that the size of the model can be significantly reduced while maintaining the accuracy of the model.

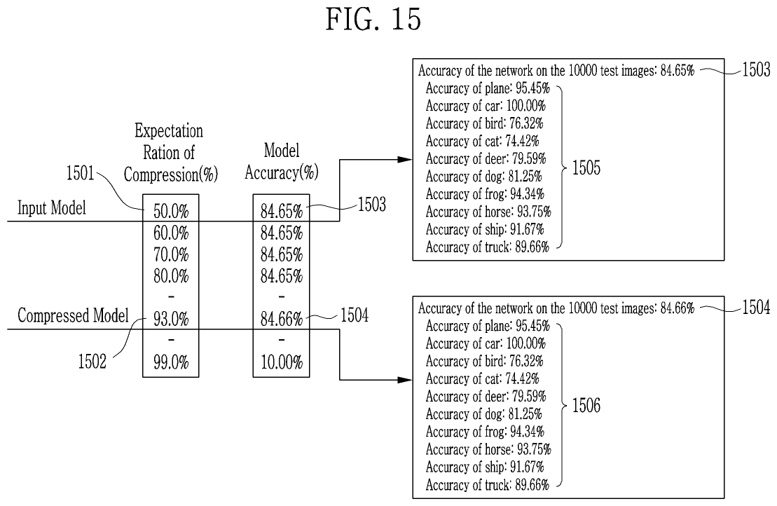

FIG. 15 is an exemplary diagram comparing the accuracy of an existing model and the accuracy of a compressed model according to a method for compressing a model according to an embodiment of the present invention.

The data set used here is a CIFAR-10 data set. For example, a total of 10 classes (for example, a plane, a car, a bird, a cat, a deer, a dog, a frog, a horse, a ship, and a truck) are identified.

The number of training data is 50,000, and the number of test data for measuring accuracy is 10,000. Here, the expectation ratio of compression is from 50% 1501 to 93.0% 1502. The accuracy 1503 of the pre-trained model (an existing model) is 84.65%, and the accuracy 1505 for each of ten classes is as shown in FIG. 15. The accuracy 1504 of the newly generated compression model is 84.66%, and the accuracy 1506 for each of ten classes is as shown in FIG. 15.

There is no loss of model accuracy, and the prediction accuracy of each class is the same for both the existing model and the newly generated compression model. Therefore, in terms of model size of the compressed model according to an embodiment of the present invention, the size of the compressed model is about 20% of the size of the existing model when there is no loss of accuracy, and the size of the compressed model is about 10% of the size of the existing model when there is loss of accuracy of about 4%. The prediction accuracy/class accuracy of the existing model also does not cause any loss.

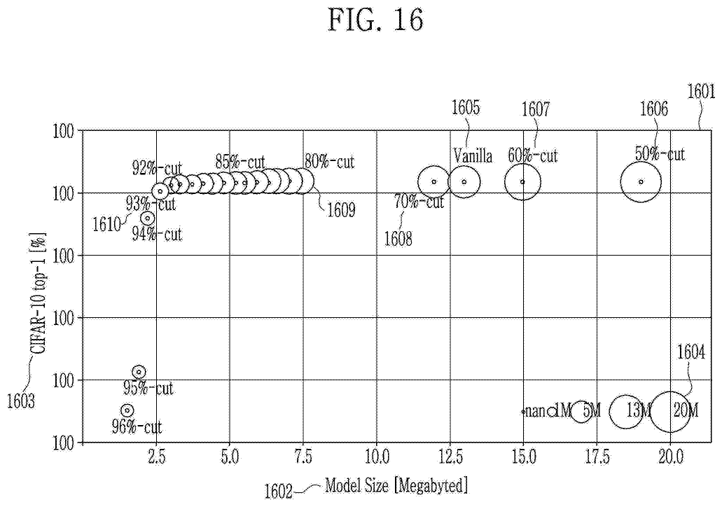

FIG. 16 is a graph 1601 illustrating model size and accuracy according to expectation ratio 1603 of compression of a model compressed in accordance with a method according to an exemplary embodiment of the present invention.

As shown in FIG. 16, Vanilla, the existing model 1605, has a model size of 13M and accuracy of 84.65%. The size of the model 1602 is represented in the graph in the form of a circle as shown in 1604 of FIG. 16. When the expectation ratio of compression is 50% (1606) and 60% (1607), the size increases due to sparse matrix transformation (matrix sparsity process) compared to the conventional model. It can be seen that the accuracy is guaranteed when the expectation ratio of compression is from 70% (1608) to 93% (1609). In cases where the expectation ratio of compression is 94% (1610) or higher, the accuracy is high.

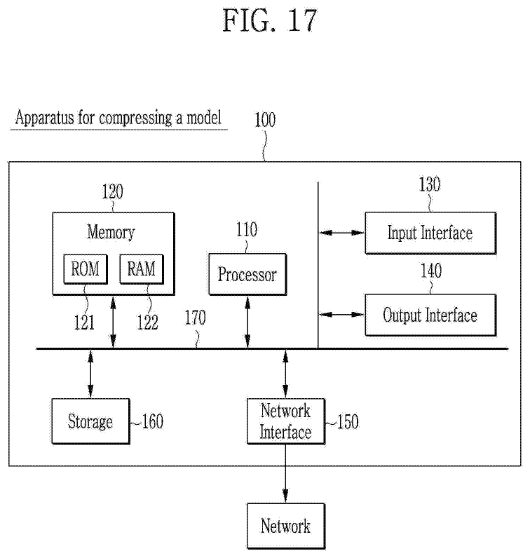

FIG. 17 is a structural diagram of an apparatus for compressing a model according to an embodiment of the present invention.

As shown in FIG. 17, the apparatus 100 for compressing a model according to an embodiment of the present invention may include a processor 110, a memory 120, an input interface device 130, an output interface device 140, a network interface 150, and storage 160, which can communicate via a bus 170.

The processor 110 may be configured to implement the methods described with reference to FIG. 4 to FIG. 9 above. The processor 110 may be a central processing unit (CPU) or a semiconductor device that executes instructions stored in the memory 120 or the storage 160.

The memory 120 is connected to the processor 110 and stores various information related to the operation of the processor 110. The memory 120 may store instructions for execution in the processor 110 or temporarily load the instructions from the storage 160. The processor 110 may execute instructions stored or loaded in the memory 120. The memory may include a read only memory (ROM) 121 and a random access memory (RAM) 122.

In an embodiment of the present disclosure, the memory 120 may be located inside or outside the processor 110, and the memory 120 may be connected to the processor 110 through various known means.

The network interface 150 is configured to be connected to a network to transmit and receive a signal.

The apparatus for compressing a model according to an embodiment of the present invention having such a structure may be implemented in the form included in the server.

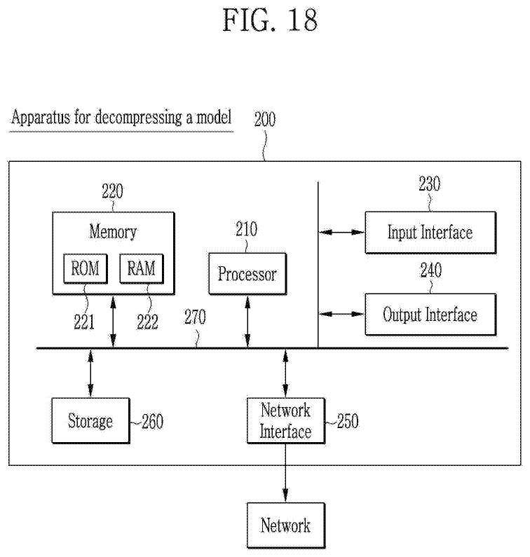

FIG. 18 is a structural diagram of an apparatus for decompressing a model according to an embodiment of the present invention.

As shown in FIG. 18, the apparatus 200 for decompressing a model according to an embodiment of the present invention may include a processor 210, a memory 220, an input interface device 230, an output interface device 240, a network interface 250, and storage 260, which may communicate over a bus 270.

The processor 210 may be configured to implement the methods described with reference to FIGS. 10 to 11 above. The processor 2110 may be a central processing unit (CPU) or a semiconductor device that executes instructions stored in the memory 220 or the storage 260.

The memory 220 is connected to the processor 210 and stores various information related to the operation of the processor 210. The memory 220 may store instructions for execution by the processor 210 or temporarily load the instructions from the storage 260. The processor 210 may execute instructions stored or loaded in the memory 220. The memory may include a ROM 221 and a RAM 222.

In an embodiment of the present disclosure, the memory 220 may be located inside or outside the processor 210, and the memory 220 may be connected to the processor 210 through various known means.

The network interface 250 is configured to be connected to a network to transmit and receive a signal. In particular, the network interface 250 is configured to receive the compressed deep learning model via the network and provide it to the processor 210.

The apparatus for decompressing a model according to an embodiment of the present invention having such a structure may be implemented in a form included in the model device.

According to an embodiment of the present invention, a lightweight model may be generated by compressing a very large sized deep learning model without loss of accuracy.

In addition, by sending a compressed model of the server-generated deep model to a mobile device, the mobile device can directly run the compressed deep learning model. This enables more reliable delivery of artificial intelligence (AI) services even when not connected to a server or cloud over the Internet.

An embodiment of the present invention is not implemented only through the above-described apparatus and/or method, but may be implemented through a program for realizing a function corresponding to the configuration of the embodiment of the present invention, a recording medium on which the program is recorded, and the like. Such implementations may be readily implemented by those skilled in the art from the description of the above-described embodiments.

Although the embodiments of the present invention have been described in detail above, the scope of the present invention is not limited thereto, and various modifications and improvements of the operator using the basic concept of the present invention as defined in the following claims are also provided, and they also belong to the scope of rights.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A method of compressing a deep learning model, comprising:
extracting, by a compression device, a threshold from a weight matrix for each layer of a pre-trained deep learning model;
generating, by the compression device, a binary mask for the weight matrix based on the threshold for each layer; and
applying, by the compression device, the binary mask to the weight matrix for each layer of the pre-trained deep learning model and performing a matrix sparsity process to generate a compression model.

2. The method of claim 1, wherein the generating a binary mask comprises:
comparing a weight value of the weight matrix with the threshold; and
generating the binary mask by assigning a value of 0 when the weight value is less than the threshold and by assigning a value of 1 when the weight value is greater than the threshold.

3. The method of claim 1, wherein the applying the binary mask comprises:
multiplying the binary mask by the weight matrix of each layer of the pre-trained deep learning model to obtain a new weight matrix to which the binary mask is applied.

4. The method of claim 1, wherein the applying the binary mask comprises:
performing a matrix sparsity process on the weight matrix to which the binary mask is applied for each layer of the pre-trained deep learning model to obtain a sparse matrix including shape information of the weight matrix, index information representing a position of a weight value, and value information representing an actual value of a weight value corresponding to the position.

5. The method of claim 1, further comprising,
before the extracting a threshold,
receiving an expectation ratio of compression,
wherein the threshold is changed according to the expectation ratio of compression.

6. The method of claim 1, further comprising,
after the applying the binary mask:
comparing accuracy of the compression model with accuracy of the pre-trained deep learning model;
changing an expectation ratio of compression when it is determined that the comparison result is within a setting range and the accuracy of the compression model is maintained at the setting level; and
ending a compression process and outputting the compressed model when it is determined that the comparison result is out of the setting range and the accuracy of the compression model is not maintained at the setting level.

7. The method of claim 6, wherein the extracting a threshold, the generating a binary mask, and the applying the binary mask based on the expectation ratio of compression being changed are repeatedly performed when it is determined that the comparison result is within the setting range.

8. The method of claim 1, further comprising:
transmitting the compression model to a terminal device via a network,
wherein the compression model has a size that is less than a size of the pre-trained deep learning model.

9. A method for decompressing a compressed deep learning model, comprising:
obtaining, by a decompression device, information of a sparse matrix from the compressed deep learning model, wherein the compressed deep learning model includes a sparse matrix for each layer compressed by a binary mask and a matrix sparsity process;
generating, by the decompression device, a matrix having values of 0 in form of one dimension for each layer of the compressed deep learning model;
substituting, by the decompression device, a value into the generated matrix based on the obtained information of the sparse matrix; and
obtaining, by the decompression device, a decompressed model by converting the matrix substituted with the value into an N-dimensional matrix.

10. The method of claim 9, wherein the information of the sparse matrix includes shape information of a weight matrix, index information representing a position of a weight value, and value information representing an actual value of a weight value corresponding to the position.

11. The method of claim 10, wherein:
the generating a matrix comprises generating a one-dimensional matrix having values of 0 based on the shape information, and
the substituting a value comprises substituting an actual value of the value information corresponding to a position of the index information into a position of the one-dimensional matrix corresponding to the position of the index information.

12. The method of claim 9, wherein the obtaining a decompressed model comprises:
converting the matrix substituted with the value into an N-dimensional matrix based on the shape information.

13. The method of claim 9, further comprising,
before the obtaining information of a sparse matrix,
receiving, by the decompression device, the compressed deep learning model via a network.

14. An apparatus for compressing, comprising:
an interface configured to receive a pre-trained model; and
a processor configured to compress the pre-trained model,
wherein the processor is configured to extract a threshold from a weight matrix for each layer of the pre-trained deep learning model, generate a binary mask for the weight matrix based on the threshold for each layer, apply the binary mask to the weight matrix for each layer of the pre-trained deep learning model, and perform a matrix sparsity process to generate a compression model.

15. The apparatus of claim 14, wherein the processor is specifically configured to generate the binary mask by comparing a weight value of the weight matrix with the threshold, multiply the binary mask by the weight matrix of each layer of the pre-trained deep learning model to obtain a new weight matrix to which the binary mask is applied, and perform a matrix sparsity process on the new weight matrix.

16. The apparatus of claim 14, wherein the processor is specifically configured to perform a matrix sparsity process on the weight matrix to which the binary mask is applied for each layer of the pre-trained deep learning model to obtain a sparse matrix including shape information of the weight matrix, index information representing a position of a weight value, and value information representing an actual value of a weight value corresponding to the position.

17. The apparatus of claim 14, wherein the threshold is changed according to the expectation ratio of compression received by the interface.
